(19) United States
(12) Patent Application Publication
(10) Pub. No.: US 2023/0400266 A1
(43) Pub. Date: Dec. 14, 2023

(54) APPARATUS FOR HIGH TEMPERATURE GAS, INCLUDING THREE-DIMENSIONAL LATTICE STRUCTURE, AND METHOD FOR MANUFACTURING SAME

(71) Applicant: CHANGWON NATIONAL UNIVERSITY INDUSTRY ACADEMY COOPERATION CORPS, Changwon-si, Gyeongsangnam-do (KR)

(72) Inventors: Seok Ho KIM, Gimhae-si (KR); Seok KIM, Changwon-si (KR); Byung Hui KIM, Busan (KR)

(73) Assignee: CHANGWON NATIONAL UNIVERSITY INDUSTRY ACADEMY COOPERATION CORPS, Changwon-si, Gyeongsangnam-do (KR)

(21) Appl. No.: 18/033,592

(22) PCT Filed: Dec. 22, 2021
(86) PCT No.: PCT/KR2021/019572

§ 371 Date: Apr. 25, 2023

(30) Foreign Application Priority Data
Dec. 28, 2020 (KR) 10-2020-0184872

(51) Int. Cl. F28F 13/00; B33Y 10/00; B33Y 80/00; B33Y 40/20; B22F 10/66; B22F 10/62; B23K 1/00; F28F 13/18

(52) U.S. Cl. CPC F28F 13/003; B33Y 10/00; B33Y 80/00; B33Y 40/20; B22F 10/66; B22F 10/62; B23K 1/0012; F28F 13/185; B22F 2998/10; B22F 2202/01; F28F 2275/04

(57) ABSTRACT

Disclosed is a device for high-temperature gas including one or more partitions and three-dimensional lattice structures of different shapes, wherein different spaces formed by the partitions include the three-dimensional lattice structures of different shapes.

### TECHNICAL FIELD

The present invention relates to a device for high-temperature gas that maximizes heat exchange efficiency by including a three-dimensional micro-lattice structure.

More specifically, the present invention relates to a technique for efficient cooling of a structure operating under a high-temperature gas atmosphere and a method of manufacturing a structure using the technique. In environments where the temperature repeatedly exceeds a limit temperature at which a material can withstand, the lifespan of a structure operating in a high temperature environment is rapidly reduced and the structure is likely to be damaged. Accordingly, the present invention relates to a cooling technique for maintaining the temperature of a structure operating in a high temperature environment below a limit temperature and a method of manufacturing a structure to which the technique is applied.

### BACKGROUND ART

Representative structures operating in high temperature environments include gas turbine blades, combustors, boilers, and the like. These structures play an important role in various industrial fields. Since these representative structures are continuously exposed to high temperature environments, the structures are made of metal materials having excellent heat resistance. However, for the purpose of improving efficiency, the temperature of an operating environment approaches the limiting temperature of the metal materials. Accordingly, a cooling technique for effectively protecting a structure operating in an extreme environment is essential.

As a representative example, in the case of a gas turbine blade, a portion of compressed air is extracted from a compressor, and the air passes through a complex cooling passage inside the turbine blade operating in a high-temperature environment. In this way, temperature in a high-temperature gas region where the blade operates is kept below the permissible temperature of metal materials, thereby increasing the lifespan of the gas turbine blade.

However, in general, since a cooling passage must be located inside a structure, it is difficult to manufacture the cooling passage due to the complex shape thereof. In addition, the cooling passage is formed in the form of a simplified monolith channel due to an increased pressure drop, which limits improvement of heat exchange efficiency, making it difficult to obtain excellent cooling characteristics.

In addition, in “NOVEL SHAPE STRUCTURE OF PIN-FIN ATTACHED TO INNER SURFACE OF COOLING PASSAGE INSIDE COOLING DEVICE” disclosed in Korean Patent Application Publication No. 10-2014-0088718, a structure in which a pin-fin of a specific shape is attached to a cooling passage is described. Since the specific shape is attached to a certain section inside, it is difficult to maximize cooling efficiency, and it is not easy to attach the specific shape.

This work was supported by the National Research Foundation of Korea (NRF) grant funded by the Government of Korea (MSIT) (No. 2019R1A5A8083201) and the Basic Science Research Program through the National Research Foundation of Korea (NRF) funded by the Ministry of Education (No. 2022R1I1A1A01061582).

### RELATED ART DOCUMENTS

### Patent Documents

(Patent Document 0001) KR 10-2014-0088718 (Publication date: Jul. 11, 2014)

### DISCLOSURE

### Technical Problem

Therefore, the present invention has been made in view of the above problems, and it is one object of the present invention to provide a device for high-temperature gas including three-dimensional lattice structures, characterized by having a large area per volume (specific surface area) compared to conventional heat exchangers by maintaining mechanical rigidity and achieving weight reduction through a phase optimization process by installing a three-dimensional micro-lattice structure inside a structure used in a high-temperature environment, such as a cooling device or a gas turbine blade, for improvement in cooling performance; and a method of manufacturing the device.

It is another object of the present invention to improve heat exchange efficiency and achieve ease of manufacture by increasing a specific surface area by applying a micro heat exchanger having a lattice shape or a shape similar to the lattice shape, which maximizes a ratio of heat transfer area to volume, to the inside of a structure operating in a high temperature environment for improvement in cooling performance.

It is yet another object of the present invention to satisfy demand for efficiency improvement through manufacturing three-dimensional laminated structures and assembling the manufactured parts and to solve problems caused by complex shapes when applying a conventional manufacturing method to parts requiring improved heat transfer efficiency.

### Technical Solution

In accordance with one aspect of the present invention, provided is a device for high-temperature gas including one or more partitions and three-dimensional lattice structures of different shapes, wherein different spaces formed by the partitions include the three-dimensional lattice structures of different shapes.

In addition, according to the present invention, the three-dimensional lattice structure may have any one of a cubic shape, an octet-truss shape, and a Kelvin shape.

In accordance with another aspect of the present invention, provided is a method of manufacturing a device for high-temperature gas including three-dimensional lattice structures, the method including a three-dimensional structure formation step of forming three-dimensional lattice structures using a 3D metal printing method; a surface strength improvement step of increasing surface strength of the three-dimensional lattice structures; and a press-fitting step of press-fitting the three-dimensional lattice structures into a device for high-temperature gas.

In addition, according to the present invention, the method may further include a brazing step of bonding the three-dimensional lattice structures after the press-fitting step.

In addition, according to the present invention, the method may include an internal strength improvement step of increasing internal strength of the device for high-temperature gas.

In addition, according to the present invention, in the surface strength improvement step or the internal strength improvement step, the strength may be increased by improving a metal structure through ultrasonic irradiation or surface rolling.

In addition, according to the present invention, the method may include a coating step of applying a nano-coating material to improve roughness of inner surface of the three-dimensional lattice structures or the device for high-temperature gas.

### Advantageous Effects

Through a device for high-temperature gas including three-dimensional lattice structures and a method of manufacturing the device, by applying a cooling structure having an optimal lattice structure or a lattice-like three-dimensional structure having excellent heat transfer characteristics depending on the temperature condition of a high temperature environment, the structure can be maintained within the allowable temperature range of a material. In addition, compared to a monolith channel structure, the micro-lattice structure can have a uniform heat flow distribution due to the characteristics of the three-dimensional structure. Accordingly, by effectively reducing thermal stress inside the cooling structure by reducing generation of hot spots in a high-temperature flow environment, sudden breakage of the structure due to creep phenomenon can be prevented and the lifespan of parts can be increased. In terms of manufacturing, simplification of manufacturing can be achieved by forming a structure having an inner space and installing and fixing a cooling structure in the inner space. Through this simplification, operating temperature and system efficiency can be increased.

### DESCRIPTION OF DRAWINGS

FIG. 1A shows examples of unit structures of various micro-lattice structures, and FIG. 1B is a graph showing specific surface area characteristics according to the micro-lattice structures.

FIG. 2 shows a ceramic micro-lattice structure implemented through manufacture of a three-dimensional laminate and the results of a high-temperature heat resistance test.

FIGS. 3A and 3B include images showing the uniform flow characteristics of a three-dimensional lattice structure in which FIG. 3A is a lattice structure, and FIG. 3B is a monolith structure.

FIG. 4 illustrates a blade including three-dimensional lattice structures according to the present invention.

FIG. 5 illustrates a heat exchanger including three-dimensional lattice structures according to the present invention.

FIG. 6 is a flowchart for explaining a method of manufacturing a device for high-temperature gas including three-dimensional lattice structures according to the present invention.

### BEST MODE

In the following description of the present invention, a detailed description of known functions and configurations incorporated herein will be omitted when it may make the subject matter of the present invention unclear. The terms used in the specification are defined in consideration of functions used in the present invention, and can be changed according to the intent or conventionally used methods of clients, operators, and users. Accordingly, definitions of the terms should be understood on the basis of the entire description of the present specification. Terms used in the detailed description are only for describing the embodiments of the present invention and should not be construed as limiting the embodiments. Singular expressions encompass plural expressions unless clearly specified otherwise in context. In this description, expression such as “comprising” or “having” is intended to indicate any features, numbers, steps, operations, elements, portions, or combinations thereof, and are not to be construed as excluding the presence or possibility of one or more other features, numbers, steps, operations, elements, portions, or combinations thereof other than those described.

Hereinafter, the embodiments of the present invention will be described in detail with reference to the drawings. The detailed description below is provided to facilitate a comprehensive understanding of the methods, apparatuses, and/or systems described herein. However, the above detailed description is only an example and the present invention is not limited thereto.

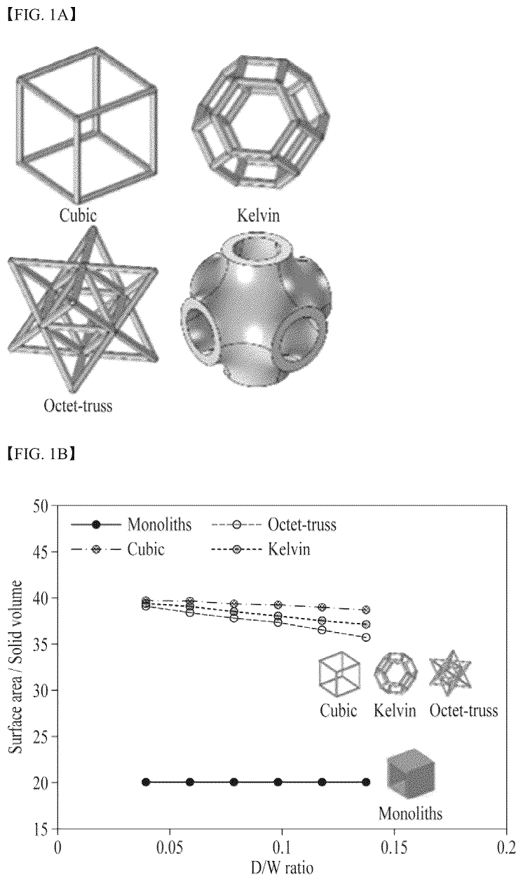

FIG. 1A shows examples of unit structures of various micro-lattice structures, and FIG. 1B is a graph showing specific surface area characteristics according to the micro-lattice structures.

As shown in FIG. 1A, the micro-lattice structures, i.e., the three-dimensional lattice structures include a cubic shape, an octet-truss shape, a Kelvin shape, and the like.

In the case of the three-dimensional lattice structures, as shown in FIG. 1B, a ratio of heat transfer area to volume may be maximized. By installing a micro heat exchanger having the lattice structure or a structure similar to the lattice structure inside a structure operating in a high temperature environment, heat exchange efficiency may be improved due to increase in a specific surface area, and ease of manufacture may be achieved.

In addition, to satisfy demand for efficiency improvement, when parts requiring improved heat transfer efficiency are manufactured using conventional manufacturing methods, it is difficult to implement complex shapes. On the other hand, when three-dimensional lattice structures are formed using a 3D lamination method, the manufactured parts are assembled, and the assembled product is inserted into a heat exchanger, a blade, or a cooling device, the above problems may be solved.

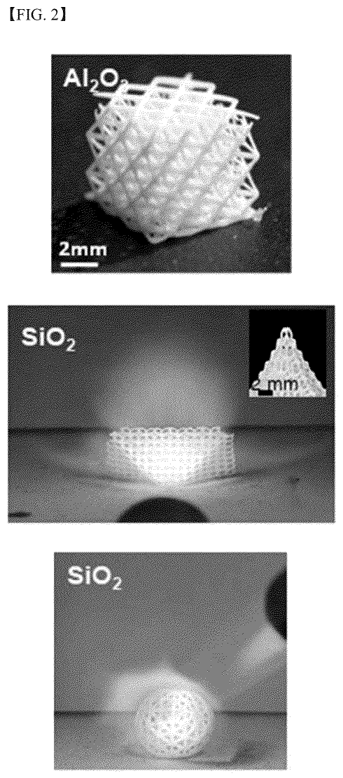

FIG. 2 shows a ceramic micro-lattice structure implemented through manufacture of a three-dimensional laminate and the results of a high-temperature heat resistance test.

As shown in FIG. 2, when a three-dimensional lattice structure was formed of a ceramic-based material, and a high-temperature heat resistance test was performed on the three-dimensional lattice structure, the three-dimensional lattice structure exhibited high cooling efficiency. Thus, when a cooling structure having an optimal lattice structure or a lattice-like three-dimensional structure having excellent heat transfer characteristics depending on the temperature conditions of high temperature environments is applied to a heat exchanger, a blade, or the like, cooling efficiency may be improved, thereby maintaining the heat exchanger, the blade, or the like within the allowable temperature range of a material.

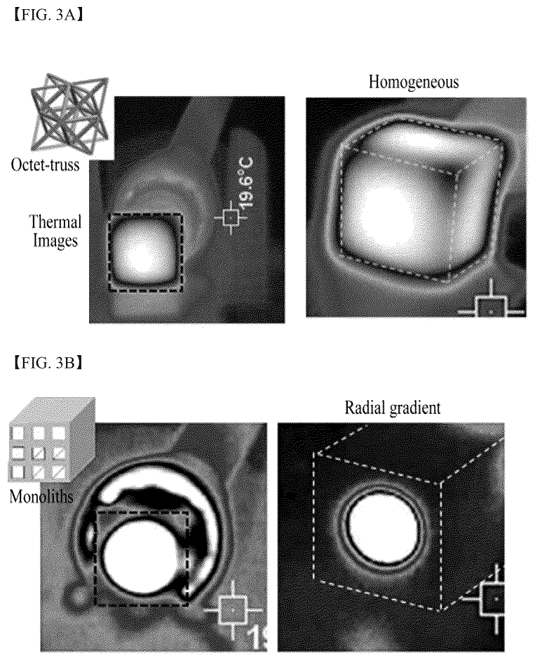

FIGS. 3A and 3B include images showing the uniform flow characteristics of a three-dimensional lattice structure in which FIG. 3A is a lattice structure, and FIG. 3B is a monolith structure.

As shown in FIGS. 3A and 3B, it was confirmed that, compared to the monolith channel structure of FIG. 3B, the micro-lattice structure of FIG. 3A exhibited a uniform heat flow distribution due to the characteristics of the three-dimensional structure. That is, by effectively reducing thermal stress inside the cooling structure by reducing generation of hot spots in a high-temperature flow environment, sudden breakage of the structure due to the creep phenomenon may be prevented, thereby increasing the lifespan of parts.

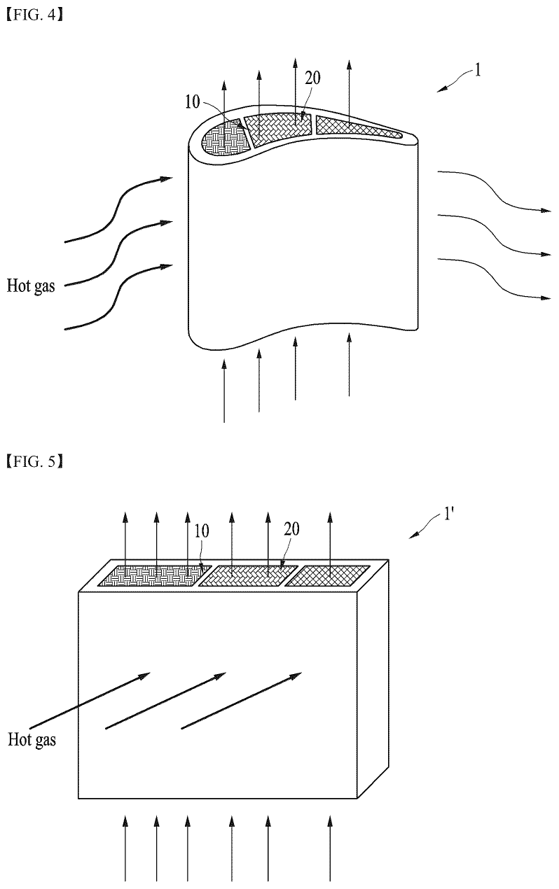

FIG. 4 illustrates a blade including three-dimensional lattice structures according to the present invention, and FIG. 5 illustrates a heat exchanger including three-dimensional lattice structures according to the present invention.

As shown in FIG. 4, a blade 1 includes one or more partitions 10, and a heat exchanger 1′ includes one or more partitions 10.

In the blade 1 or the heat exchanger 1′, three-dimensional lattice structures 20 of different shapes are insert into different internal spaces formed by the partitions 10 and fixed thereto.

The three-dimensional lattice structures 20 may have any one of a cubic shape, an octet-truss shape, and a Kelvin shape, without being limited thereto.

As shown in FIGS. 1 to 3B, since the three-dimensional lattice structures 20 of various shapes have different heat transfer characteristics, depending on the characteristics of the blade 1, the heat exchanger 1′, or the device for high-temperature gas used in a high temperature environment and the temperature distribution of high-temperature gas, a suitable three-dimensional lattice structure is preferably used.

At this time, depending on temperature characteristics, the inside of the blade 1 or the heat exchanger 1′ may be divided by one or more lattices 10, and the shape of the three-dimensional lattice structure 20 in the section where hot gas is introduced may be different from the shape of the three-dimensional lattice structure 20 in the section where the hot gas is discharged, or the densities of the three-dimensional lattice structures 20 inserted into the blade 1 or the heat exchanger 1′ may be different.

That is, when the temperature of high-temperature gas flowing into the device for high-temperature gas is different, or when high-temperature gas passes through the device for high-temperature gas and the temperature of the gas changes, the characteristics of the high-temperature gas change. At this time, to transfer heat under optimal conditions and maximize heat transfer efficiency, the three-dimensional lattice structures 20 of different shapes are arranged in different spaces separated by the partitions 10.

Here, structures used in a high-temperature gas environment, such as the blade 1 and the heat exchanger 1′, are collectively referred to as a device for high-temperature gas.

When the three-dimensional lattice structures 20 are inserted into the blade 1 or the heat exchanger 1′, both the shape and density of the three-dimensional lattice structures 20 may be different, or the shape or density thereof may be different.

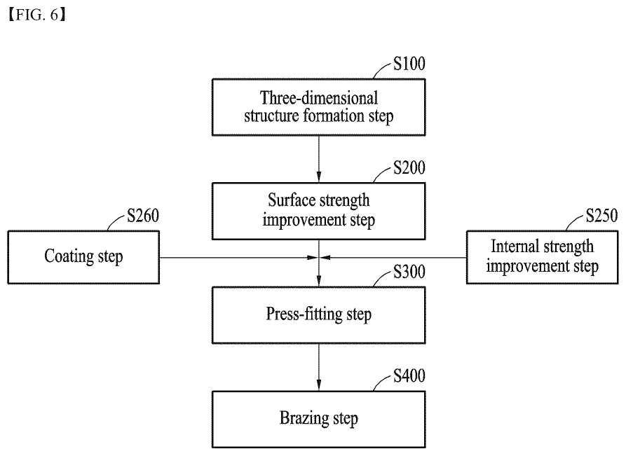

FIG. 6 is a flowchart for explaining a method of manufacturing a device for high-temperature gas including three-dimensional lattice structures according to the present invention.

As shown in FIG. 6, a three-dimensional structure formation step (S100) of forming the three-dimensional lattice structures 20 inserted into a device for high-temperature gas, such as the blade 1 or the heat exchanger 1′, using a 3D metal printing method is performed.

After forming the three-dimensional lattice structures 20, a surface strength improvement step (S200) of increasing the surface strength of the three-dimensional lattice structures 20 is performed.

At this time, surface strength may be increased by modifying the surface of a metal by applying micro-vibration through ultrasonic irradiation to the surface thereof.

After improving surface strength, a press-fitting step (S300) of press-fitting the three-dimensional lattice structures 20 into a device for high-temperature gas is performed.

When the three-dimensional lattice structures 20 are fixed in the press-fitting manner inside the device for high-temperature gas through the press-fitting step (S300), in the case of the heat exchanger 1′ to which no physical force is applied, the device may be used immediately without any additional steps. In the case of the blade 1 to which external physical force is continuously applied, since it may be difficult to fix the structures only by press-fitting, a brazing step (S400) of bonding the three-dimensional lattice structures 20 to the outer circumference of the device for high-temperature gas by welding is performed after press-fitting.

In addition, when the three-dimensional lattice structures 20 are press-fitted into the device for high-temperature gas, the inner surface of the device for high-temperature gas may be damaged. Thus, before press-fitting, an internal strength improvement step (S250) of increasing the internal strength of the device for high-temperature gas may be performed.

At this time, in the internal strength improvement step (S250), surface strength may be increased by modifying the surface of a metal by applying micro-vibration through ultrasonic irradiation to the surface thereof, or surface strength may be increased by improving a metal structure through surface rolling.

In addition, before press-fitting, a coating step (S260) of applying a nano-coating material to improve the roughness of inner surface of the three-dimensional lattice structures 20 or the device for high-temperature gas may be additionally performed.

By improving surface roughness, when press-fitting the three-dimensional lattice structures 20 into the device for high-temperature gas, damage to the device for high-temperature gas and the three-dimensional lattice structures 20 due to frictional damage may be prevented, or a phenomenon in which thermal stress is concentrated due to scratches may be prevented.

The aforementioned description of the present invention is provided by way of example, and those skilled in the art will understand that the present invention can be easily changed or modified into other specified forms without change or modification of the technical spirit or essential characteristics of the present invention. Therefore, it should be understood that the aforementioned examples are only provided by way of example and not provided to limit the present invention.

It should be understood that the scope of the present invention is defined by the following claims and the invention is to cover all modifications, equivalents, and alternatives falling within the spirit and scope of the invention as defined by the claims.

### DESCRIPTION OF SYMBOLS

1: BLADE
1′: HEAT EXCHANGER
10: PARTITIONS
20: THREE-DIMENSIONAL LATTICE STRUCTURES
S100: THREE-DIMENSIONAL STRUCTURE FORMATION
S200: SURFACE STRENGTH IMPROVEMENT STEP
S250: INTERNAL STRENGTH IMPROVEMENT STEP
S260: COATING STEP
S300: PRESS-FITTING STEP
S400: BRAZING STEP

1. A device for high-temperature gas, comprising:
one or more partitions; and
three-dimensional lattice structures of different shapes,
wherein different spaces formed by the partitions comprise the three-dimensional lattice structures of different shapes.

2. The device according to claim 1, wherein the three-dimensional lattice structure has any one of a cubic shape, an octet-truss shape, and a Kelvin shape.

3. A method of manufacturing a device for high-temperature gas comprising three-dimensional lattice structures, comprising:
a three-dimensional structure formation step of forming three-dimensional lattice structures using a 3D metal printing method;
a surface strength improvement step of increasing surface strength of the three-dimensional lattice structures; and
a press-fitting step of press-fitting the three-dimensional lattice structures into a device for high-temperature gas.

4. The method according to claim 3, comprising an internal strength improvement step of increasing internal strength of the device for high-temperature gas.

5. The method according to claim 4, wherein, in the surface strength improvement step or the internal strength improvement step, the strength is increased by improving a metal structure through ultrasonic irradiation or surface rolling.

6. The method according to claim 5, comprising a coating step of applying a nano-coating material to improve roughness of inner surface of the three-dimensional lattice structures or the device for high-temperature gas.

7. The method according to claim 6, further comprising a brazing step of bonding the three-dimensional lattice structures after the press-fitting step.
